(19) United States
(12) Patent Application Publication
(10) Pub. No.: US 2007/0146344 A1
(43) Pub. Date: Jun. 28, 2007

(54) METHOD AND APPARATUS FOR REDUCING POWER CONSUMPTION IN A DISPLAY FOR AN ELECTRONIC DEVICE

(75) Inventors: Daryl Martin, Paradise (CA); J.F. Sean Wilson, Waterloo (CA); Ahmed E. Hassan, Waterloo (CA); Mark Michael, Kitchener (CA)

Correspondence Address: RIDOUT & MAYBEE;SUITE 2400, ONE QUEEN STREET EAST, TORONTO, ON, M5C3B1, CA

(73) Assignee: RESEARCH IN MOTION LIMITED, Waterloo (CA)

(21) Appl. No.: 11/614,278

(22) Filed: Dec. 21, 2006

Related U.S. Application Data
(60) Provisional application No. 60/752,406, filed on Dec. 22, 2005.

(51) Int. Cl. G09G 5/00

(52) U.S. Cl. 345/173

(57) ABSTRACT

A display module comprising a display screen; a controller, said controller having an input for receiving information, and an output coupled to said display screen for outputting display information to said display screen; said controller including a component for determining an area of interest on said display screen; and said controller having a component for dimming at least a portion of said display screen outside of said area of interest.

This application claims priority to and the benefit of U.S. Provisional Patent Application Ser. No. 60/752,406 Filed Dec. 22, 2005.

### FIELD OF THE INVENTION

The present application relates generally to displays and, more specifically, to a method and apparatus for reducing power consumption in a display for an electronic device.

### BACKGROUND OF THE INVENTION

The mobile electronic device market is currently experiencing challenges related to battery life because of continuing demands for higher resolution and brighter, larger displays. As such, power consumption becomes a serious concern in the mobile market as the demand for more power continues to outstrip the development of battery technology.

Conventional portable devices offer little or no control over the amount of power consumed by the display. While some devices allow a user to completely turn off the display or vary the brightness of the entire display uniformly, there remains a need for varying the brightness or intensity of selected portions of the display. Additionally, there remains a need for a power saving scheme that is able to vary the brightness of a display continuously such that the brightness changes or decreases continuously as one progresses away from an area of focus of the user.

### BRIEF DESCRIPTION OF THE DRAWINGS

Reference will now be made to the drawings, which show by way of example, embodiments of the invention, and in which:

FIG. 1 shows in block diagram form a communication system suitable for an electronic device having a display module in accordance with one embodiment;

FIG. 2 shows in diagrammatic form a mobile electronic device according to another embodiment for use with the communication system of FIG. 1;

FIG. 3 shows in schematic form a transmissive mode LCD screen for one embodiment of a display module for the mobile electronic device;

FIG. 4 shows in schematic form an LCD driver circuit and the LCD screen of FIG. 3;

FIG. 5 is a front view of the mobile electronic device of FIG. 1;

FIG. 6 shows in flowchart form an embodiment of a method for operating the display module.

FIG. 7 shows in schematic form a display module for the mobile electronic device according to another embodiment; and

FIG. 8 shows in schematic form a display module for the mobile electronic device according to another embodiment.

In the drawings, like reference numerals denote like elements or features.

### DETAILED DESCRIPTION OF THE EMBODIMENTS

One embodiment of the present invention comprises a display module and the display module includes, a display screen; a controller, the controller has an input for receiving information, and an output coupled to the display screen for outputting display information to the display screen; the controller includes a component for determining an area of interest on the display screen; and the controller has a component for dimming at least a portion of the display screen outside of the area of interest.

Another embodiment comprises a method of controlling a display for an electronic device, the method includes the steps of, displaying an image on the display; defining an area of interest on the display; dimming at least a portion of the displayed image outside the area of interest.

Another embodiment comprises a mobile electronic device, the mobile electronic device includes, an input device; a liquid crystal display including, a display screen; a controller, the controller having an input for receiving information, and an output for outputting display information to the display screen; the controller includes a component for determining an area of interest on the display screen, and the controller has a component for dimming at least a portion of the display screen outside of the area of interest.

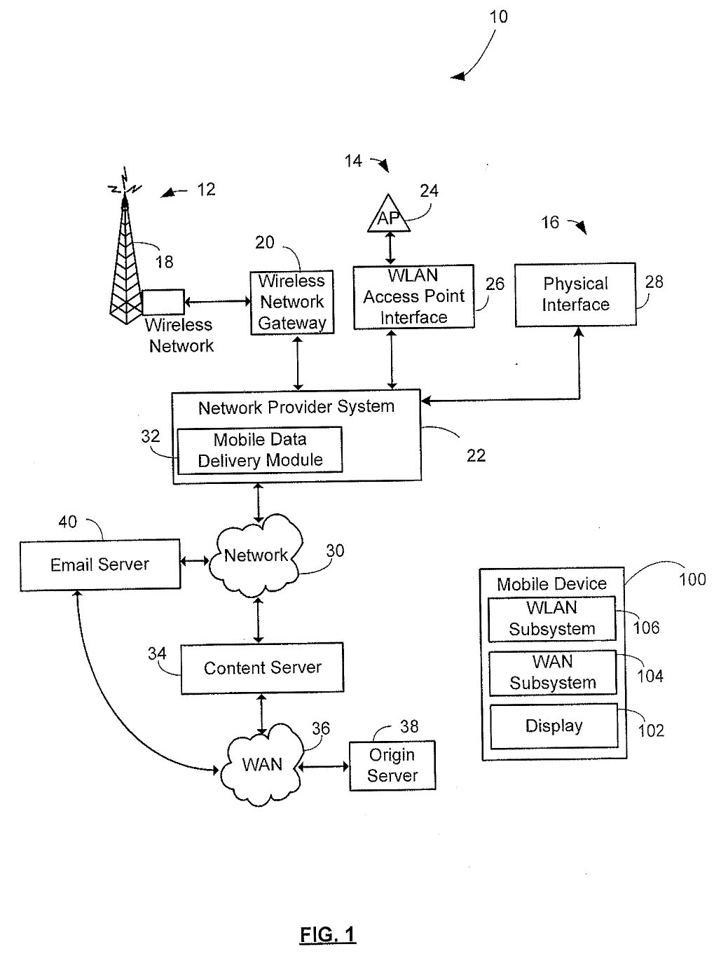

Reference is made to FIG. 1, which shows a communication system 10 suitable for a device, e.g., a mobile electronic device, having a display module according to one embodiment. The communication system 10 generally includes one or more mobile electronic devices 100 (only one of which is shown in FIG. 1), a wireless Wide Area Network (WAN) 12, a Wireless Local Area Network (WLAN) 14, and/or other interfaces 16. The mobile electronic device 100 includes a display module indicated generally by reference 102, and as will be described in more detail below, the display module 102 comprises a number of embodiments. While the display module 102 is described in the context of the mobile electronic device 100 and the associated communication system 10, it will be understood by those skilled in the art that the display module 102 finds application in other types of devices or systems. Such applications include a full-sized liquid crystal display (LCD) for a personal computer, a display module for a clock or watch, a display module for a personal digital assistant (PDA) or a cellular phone, an automobile dash display, audio/video electronic device displays (e.g. DVD players), etc.

Referring to FIG. 1, the wireless WAN 12 may be implemented as a packet-based cellular network that includes a number of base stations 18 (one of which is shown in FIG. 1) where each of the base stations 18 provides wireless Radio Frequency (RF) coverage to a corresponding area or cell. The wireless WAN 12 is typically operated by a cellular network service provider that sells subscription packages to users of mobile electronic devices. The wireless WAN 12 comprises a number of different types of networks, for example, Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network) or various other third generation networks such as EDGE (Enhanced Data rates for GSM Evolution) or UMTS (Universal Mobile Telecommunications Systems).

As shown in FIG. 1, the communications system 10 also includes a wireless network gateway 20 and one or more network provider systems 22. The wireless network gateway 20 provides translation and routing services between the network provider system(s) 22 and the WAN 12 which facilitates communication between the mobile electronic devices 100 and other devices (not shown) connected, directly or indirectly, to the network provider system 22.

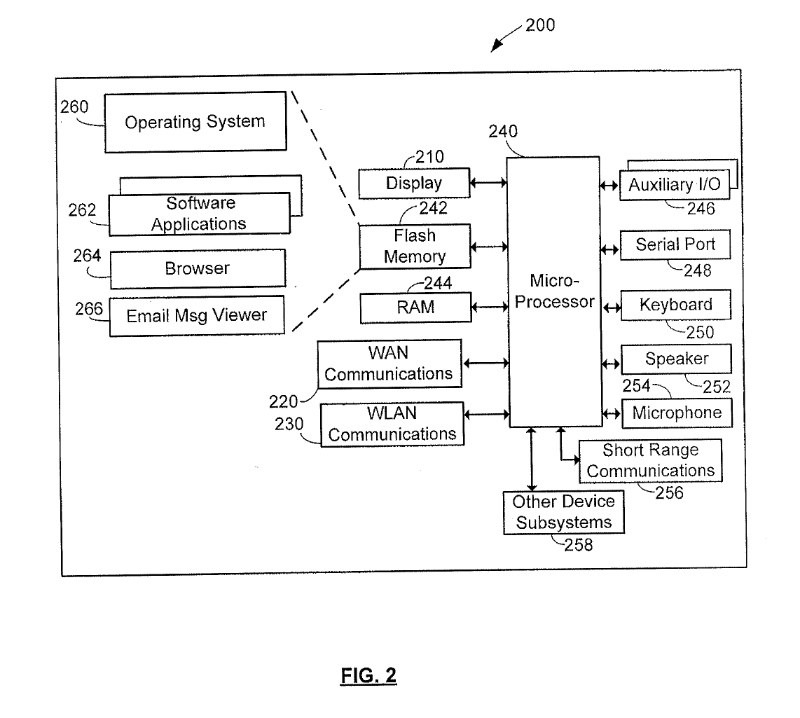

The WLAN 14 comprises a network which in some example conforms to IEEE 802.11 standards such as 802.11b and/or 802.11g; however, other communications protocols may also be used for the WLAN 14. The WLAN 14 includes one or more wireless RF Access Points (AP) 24 (one of which is shown in FIG. 1) that collectively provide a WLAN coverage area. For the embodiment depicted in FIG. 1, the WLAN 14 is operated by an enterprise (for example, a business or university) and the access points 24 are connected to an access point (AP) interface 26. The AP interface 26 provides translation and routing services between the access points 24 and the network provider system 22 to facilitate communication between the mobile electronic devices 200 (FIG. 2) and other devices connected, directly or indirectly, to the network provider system 22. The AP interface 24 is implemented using a computer, for example, a server running a suitable computer program or software.

According to one embodiment, the other interfaces 16 may be implemented using a physical interface indicated by the reference 28. The physical interface 28 includes an Ethernet, Universal Serial Bus (USB), Firewire, or infrared (IR) connection implemented to exchange information between the network provider system 22 and the mobile electronic device 100.

The network provider system 22 comprises a server which is located behind a firewall (not shown). The network provider system 22 provides access for the mobile electronic devices 100, through either the wireless WAN 12, the WLAN 14, or the other connection 16 to the devices connected, for example, through an enterprise network 30 (e.g., an intranet), to the network provider system 22. In one embodiment, the data delivery module 32 is implemented on a computer, such as the network provider system 22.

The enterprise network 30 comprises a local area network, an intranet, the Internet, a direct connection, or combinations thereof. According to one embodiment, the enterprise network 30 comprises an intranet for a corporation or other type of organization. As shown in FIG. 1, an application/content server 34 may be connected to the enterprise network 30 and also to another network, for example a Wide Area Network (WAN), indicated by reference 36. The WAN 36 may further connect to other networks. In one embodiment, the WAN 36 comprises or is configured with the Internet, a direct connection, a LAN, a wireless communication link, or any combination thereof. Content providers, such as Web servers, may be connected to the WAN 36, an example of which is shown in FIG. 1 as an origin server, indicated by reference 38. In one example configuration, an email server 40 is connected to the enterprise network 30. The email server 40 is configured to direct or redirect email messages received over the WAN 36 and internally within the enterprise network 30 to be addressed to the mobile electronic device(s) 100.

According to one embodiment, the mobile data delivery module 32 provides HTTP connectivity between the wireless WAN 12 and the WLAN 14 and the other connection 16 and devices and/or networks connected directly or indirectly to the network provider system 22. The network 30, the application/content server 34, the WAN 36 and the origin server 38 are individually and/or collectively in various combinations a content source for the network provider system 22. It will be appreciated that the system shown in FIG. 1 comprises one possible communication network or configuration for use with the mobile communication device 100.

The mobile electronic devices 100 are configured to operate, as described above with reference to FIG. 1, within the wireless WAN 12 and the WLAN 14. As shown in FIG. 1, the mobile electronic device 100 is configured or includes a WAN communications subsystem 104 for communicating with the wireless WAN 12 and a WLAN communications subsystem 106 for communicating with the access points 24 of the WLAN 14. The mobile electronic device 100 also includes the display module 102, embodiments of which will be described in more detail below.

Reference is next made to FIG. 2, which shows an embodiment of the mobile electronic device and is indicated generally by reference 200. The mobile electronic device 200 includes a display module 210 which generally corresponds to the display module 102 of FIG. 1. The mobile electronic device 200 includes a wireless WAN communication subsystem 220 for two-way communications with the wireless WAN 12 (FIG. 1), and the WLAN communications subsystem 230 for two-way communications with the WLAN 14 (FIG. 1). According to one embodiment, the communications subsystems 220 and 230 include respective antennas (not shown), RF transceivers (not shown), and some signal processing capabilities, implemented, for example, by a digital signal processor (not shown). The mobile electronic device 200 also includes a microprocessor 240 which is suitably programmed to control the overall operation and functions of the mobile electronic device 200, which are described in more detail below. The mobile electronic device 200 includes peripheral devices or subsystems such as a flash memory 242, a random access memory (RAM) 244, an auxiliary input/output (I/O) subsystem 246 (e.g. an external communications link such as Ethernet), a serial port 248 (e.g. a USB port), an input device 250 (e.g. a keyboard or keypad), a speaker 252, a microphone 254, a short-range communications subsystem 256 (e.g. an infrared transceiver), and any other device subsystems generally designated by reference 258.

The microprocessor 240 operates under stored program control with code or firmware being stored in the flash memory 242 (or other type of non-volatile memory device or devices). As depicted in FIG. 2, the stored programs (e.g. firmware or other programming) includes an operating system program or code module 260 and other programs or software applications indicated generally by reference 262. The software applications 262 for a Web-enabled embodiment or implementation of the mobile electronic device 200 comprise a Web browser 264 and an email message viewer 266. Each of the software applications 262 may include layout information defining the placement of particular fields, such as text fields, input fields, etc., in a user interface for the software application 262. The operating system code 260, code for specific device applications 262, or code components thereof, may be temporarily loaded into a volatile storage medium such as the RAM 244. Received communication signals and other data with information may also be stored in the RAM 244.

The stored program control (i.e., software applications 262) for the microprocessor 240 also includes a predetermined set of applications or code components or software modules that control basic device operations, for example, data and voice communication applications which are normally installed on the mobile electronic device 200 as the software applications 262 during the manufacturing process. Further applications may also be loaded (i.e. downloaded) onto the mobile electronic device 200 through the operation of networks described above for FIG. 1, the auxiliary I/O subsystem 246, the serial port 26, or the short-range communications subsystem 256. The downloaded code module or components are then installed by the user (or automatically) in the RAM 244 or the non-volatile program memory (e.g. the flash memory 242).

The serial port 248 comprises a USB type interface port for interfacing or synchronizing with another device, such as, a desktop computer (not shown). The serial port 248 is used to set preferences through an external device or software application. The serial port 248 is also used to extend the capabilities of the mobile electronic device 200 by providing for information or software downloads, including user interface information, to the mobile electronic device 200 other than through a wireless communication network, described above for FIG. 1.

The short-range communications subsystem 256 provides an interface for communication between the mobile electronic device 200 and different systems or devices, which need not necessarily be similar devices. For example, the subsystem 256 comprises an infrared communication link or channel.

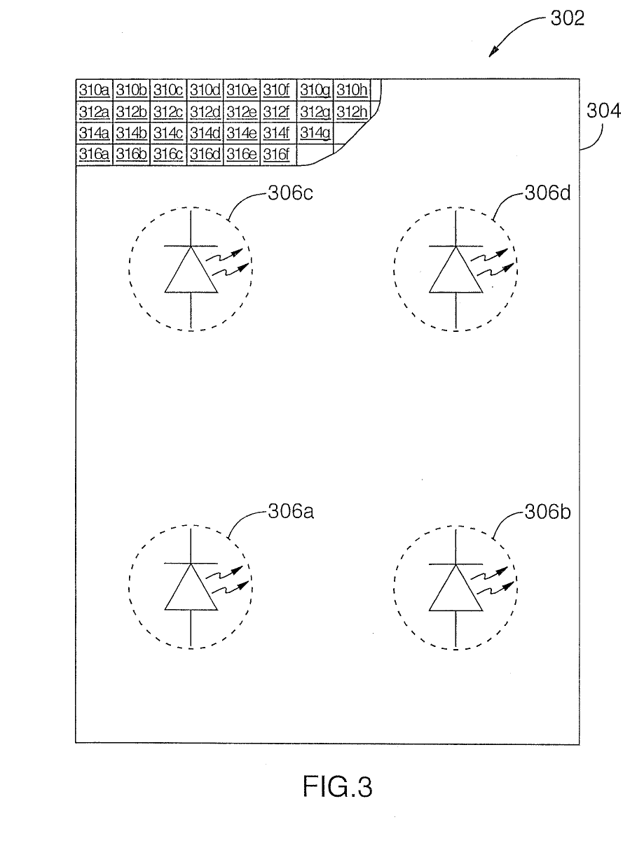

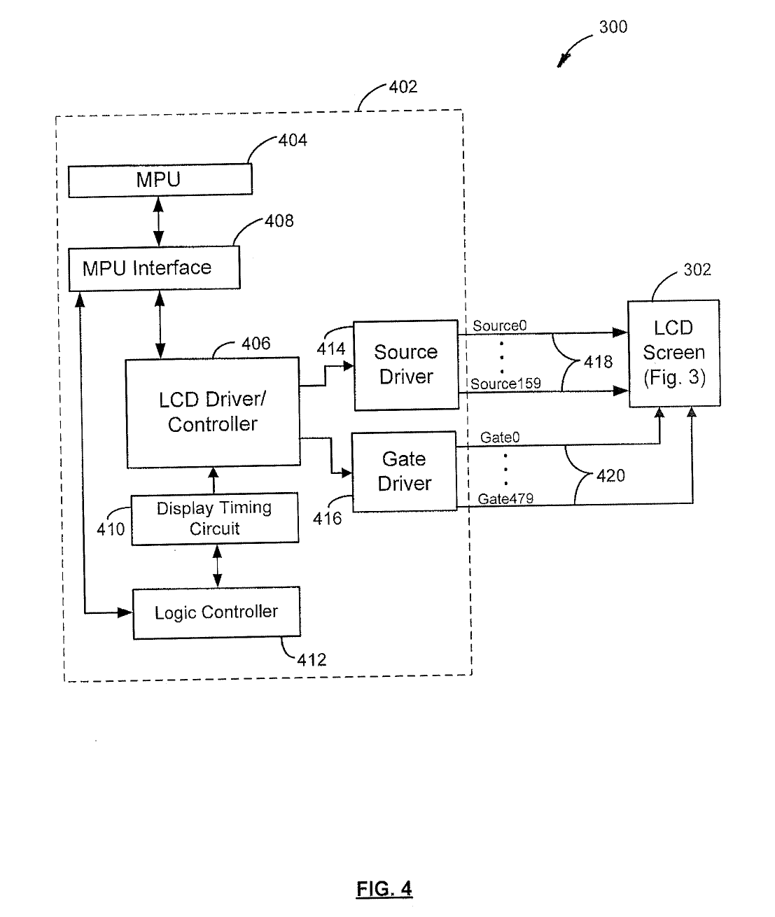

Reference is next made to FIG. 4, which shows an embodiment of the display module 102 (FIG. 1) or 210 (FIG. 2) comprising a LCD display module indicated generally by reference 300. The LCD display module 300 comprises a LCD display screen 302 (as shown in FIGS. 3 and 4) and a LCD driver circuit as shown in FIG. 4 and indicated generally by reference 402. According to this embodiment of the display module 300, the LCD display screen 302 comprises a transmissive mode normally black liquid crystal display (LCD). In the transmissive mode LCD screen 302, the liquid crystal elements function as light valves, and the screen is normally black when no power is applied. When power is applied, the liquid crystal elements are oriented and light (e.g. from a backlight) is allowed to pass and the element appears illuminated, e.g. white for monochromatic display screen or red, blue or green (or a combination thereof) for a colour display screen.

Referring to FIG. 3, the LCD display screen 302 comprises a liquid crystal display (LCD) panel 304 and one or more backlights 306, indicated individually by references 306a, 306b, 306c, and 306d in FIG. 3. The liquid crystal panel 304 is constructed using a sandwich or layer configuration as will be understood by one skilled in the art. As shown the LCD panel 304 is divided into picture elements or pixels, for example, as a matrix comprising row and columns. The liquid display panel 304 includes a partial sectional view showing some of the pixels, indicated by references 310a, 310b, 310c . . . 310k, 312a, 312b, 312c . . . 312h, 314a, 314b, 314c . . . 314g, 316a, 316b, 316c . . . 316f. Each of the pixels may further comprise three or four sub-pixels, with each sub-pixel providing a colour element, for example, red, green and blue. Each pixel or sub-pixel is controlled by a transistor in the driver circuit 402 (as described in more detail below).

Reference is made back to FIG. 4, which shows in schematic form an embodiment for the driver circuit 402. The driver circuit 402 comprises an active matrix LCD technology which utilizes at least one transistor per sub-pixel, and includes a microprocessor unit (MPU) or microcontroller unit (MCU) 404. The microprocessor 404 operates under stored program control to provide the control and display functions for the LCD display module 300. The LCD driver circuit 402 comprises an LCD driver/controller 406 which is coupled to the microprocessor 404 through a MPU interface indicated by reference 408. The MPU interface 408 converts signals and data from the microprocessor 404 into LCD driver data for the LCD driver/controller 406. As shown, the LCD driver circuit 402 includes a display timing circuit 410 and a logic controller 412. The display timing circuit 410 generates timing (e.g. refresh) signals for the LCD driver/controller 406 under the control of the logic controller 412 which is coupled to the microprocessor 404 through the MPU interface 408. The LCD driver/controller 406 includes RAM which is used as a frame buffer for data to be displayed on the LCD screen 302. In one embodiment, some or all of the functionality associated with the LCD driver/controller 406 may be combined or integrated with the firmware or other programming used to control the microprocessor 240 (FIG. 2).

As shown in FIG. 4, the LCD driver circuit 402 also includes a source driver circuit 414 and a gate driver circuit 416. The source driver circuit 414 functions to drive one terminal (i.e. the source terminal) of the transistors in the pixels (and sub-pixels) in the LCD screen 302. Similarly, the gate driver circuit 416 functions to drive another terminal (i.e. the gate terminal) of the transistors in the pixels (and sub-pixels) in the LCD screen 302. According to this embodiment, the LCD screen 302 comprises 160×160 pixels, with each pixel having at least 3 transistors. The pixels are controlled by 160 source lines (i.e. Source0-Source159) indicated by reference 418 from the source driver circuit 414, and by 480 gate lines (i.e. Gate0-Gate479) indicated by reference 420 from the gate driver circuit 416.

In operation, the LCD driver/controller 406 receives data from the microprocessor 404 and combines it with data from the display timing circuit 410. The display timing circuit 410 defines the frame frequency for the LCD screen 302 and determines when the sources and gates of the transistors for the pixels in the LCD screen 302 are driven. The LCD driver/controller 406 converts the combination of data from the microprocessor 404 and the display timing circuit 410 to driver data and sends it to the source driver circuit 414 and the gate driver circuit 416, which respectively drive the source lines 418 and the gate lines 420.

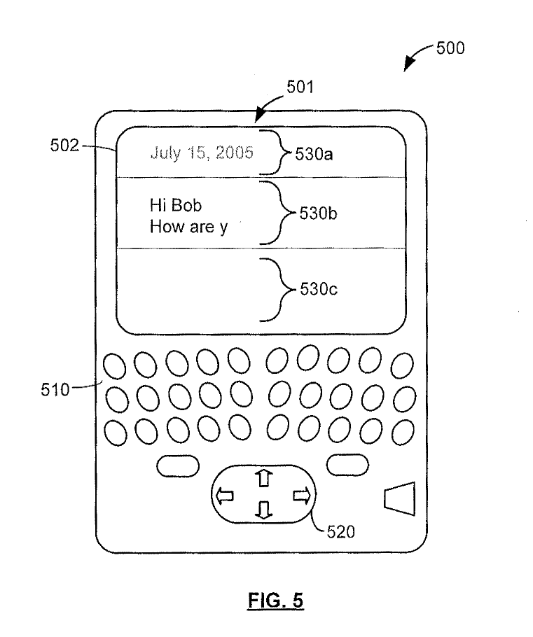

Reference is next made to FIG. 5, which illustrates operation of the mobile electronic device with the display module 300 (FIG. 3) according to one embodiment. In FIG. 5, the mobile electronic device is indicated generally by reference 500 and the display module by reference 501. In addition to the display module 501, the mobile electronic device 500 includes a keypad or keyboard 510 and a navigator pad 520. As described above, the display module 501 comprises a LCD display screen 502 and a LCD driver circuit (not shown, but similar, for example, to the LCD drive circuit 402 depicted in FIG. 4). According to this embodiment, the LCD display screen 502 displays or presents a display image and comprises three general display areas 530, indicated individually by references 530a, 530b, and 530c. Each of the display areas 530 has a brightness or intensity level which is individually adjustable or variable, or adjustable relative to the brightness or intensity of any of the other display regions, as will be described in more detail below. In one embodiment, each of the display regions 530 is defined in software (e.g. firmware or otherwise) by mapping or correlating the pixels belonging to the respective display area 530, i.e. the respective display area comprises a mask or overlay mapped in software to a group of pixels in the display screen 502. By applying the mask or overlay map to control the display screen 502, the display image (i.e. the pixels representing the display image) is altered in appearance (i.e. brightness levels) when it is displayed on the LCD display screen 502. In another embodiment, the display module 501 comprises three or more separate LCD display screens which are physically joined but have individual LCD driver circuits which function under the control of the microprocessor 240 (FIG. 2).

Referring to FIG. 5, the display area 530b comprises a region or an area where a user is currently entering text (e.g. “Hi Bob How are y . . . ), i.e. an area of focus or an area of interest, and in accordance with this embodiment the display area 530b is presented (i.e. displayed) at a normal or maximum brightness level. The two other display areas 530a and 530c represent areas or regions of non-focus or non-interest, and according to this embodiment are presented at a decreased or dimmer brightness level, e.g. relative to the brightness level of the area of focus, i.e. the display area 530b. Thus, the areas outside of the area of focus 530b are dimmed relative to how those areas would normally appear. As the user moves a cursor (for example, using the keypad 510 or the navigator pad 520) around on the display screen 502, the microprocessor 240 (FIG. 2) includes and executes a function or routine under the control of firmware or other programming which tracks the focus point and controls the display screen 502 (i.e. the pixels) so that the image in the display area with the focus point (e.g. the display area 530b) is displayed at a normal brightness level while the display screen 502 with the other display areas (e.g. 530a and 530c) away from the area of the user's focus is dimmed or appears at brightness level which is less than the level for the area of focus. Under the control of firmware or other programming, the non-focus display areas 530a and 530c are either dimmed at an equal or uniform brightness level, or have a continuously decreasing brightness such that the portions of the display areas 530a and 530c furthest away from the display area 530b are darkest. The dimming of the non-focus display areas 530a and 530c is accomplished under the control of firmware (or other programming) by altering the appearance of the display image being displayed through the dimming of the pixels in the respective non-focus display areas 530a or 530c. According to this embodiment, the firmware or other programming includes a function or code component for dimming all of the pixels in the non-focus display area 530c, a function or code component for dimming most of the pixels in the display area 530b and/or a function or code component for dimming some of the pixels in the display area 530a (for example, the pixels the farthest from the focus display area 530b). As described above, the dimming functions may be implemented by mapping the pixels to an overlay or mask which is then applied to the LCD display screen 502. The dimming overlay or mask is varied or adjusted according to the location of the focus point. In other words, the LCD display screen 502 is controlled to alter the display image, i.e. the pixels corresponding to the area(s) of the display image outside of the focus display area or area of interest are dimmed (i.e. controlled to provide a lower brightness level or intensity level). In another embodiment, the display areas 530a, 530b, and 530c do not have defined boundaries, and the LCD display screen 502 is controlled to provide a continuously variable brightness and produce a display image that fades the further one progresses away from the selected area or area of focus (e.g. the display area 530b). In another embodiment, the display areas 530a, 530b, and 530c are configured vertically, or in any other orientation. In another embodiment, the pixels for the display areas 530a, 530b or 530c are mapped or configured in any shape or size, for example, a square, a rectangle, etc. In another embodiment, the processing associate with the method may be implemented, in part, with the functionality of the LCD driver/controller 406 (FIG. 4).

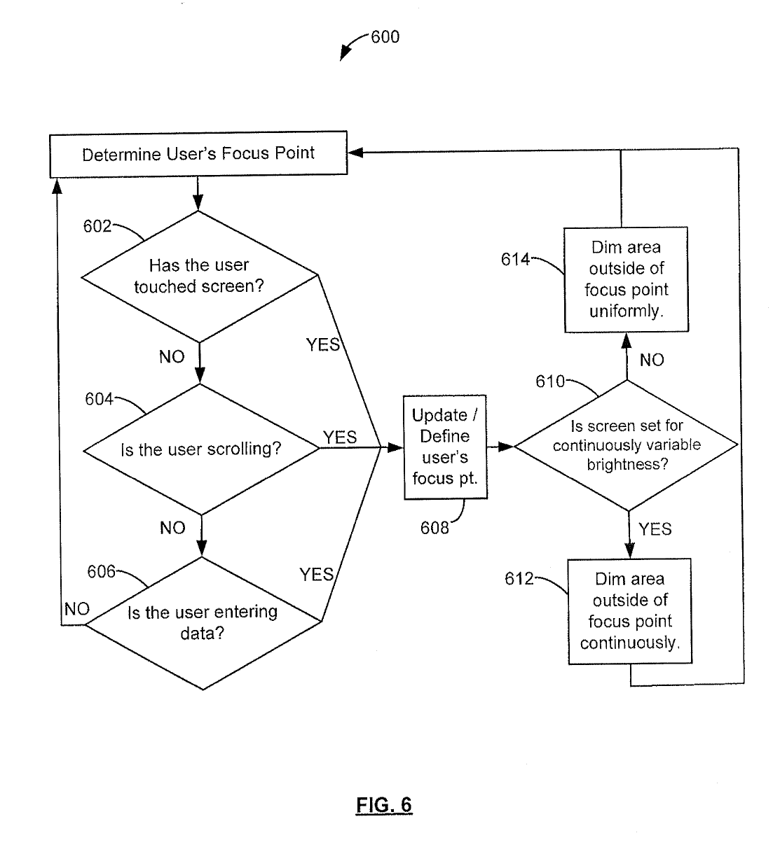

Reference is next made to FIG. 6, which shows in flowchart form an embodiment of a method for determining a user's focus point (i.e. an area of interest or activity) and adjusting the brightness levels of the display screen 502 accordingly. The method according to this embodiment is indicated generally by reference 600.

As shown in FIG. 6, the first step or operation according to the method 600 comprises control circuitry (i.e. the microprocessor 240 in FIG. 2 operating under stored program control) determining if the user has touched or activated the display screen (decision block 602). If the user has touched the display screen (as determined in decision block 602), the next operation in block 608 comprises control circuitry (i.e. the microprocessor 240 operating under stored program control or firmware) updating or defining a focus point for the user. If the user has not touched the display screen (i.e. as determined in decision block 602), then the next operation in decision block 604 comprises determining if the user is scrolling on the display screen. If the user is scrolling (as determined in decision block 604), then the next operation in block 608 comprises updating the focus point. If the user is not scrolling (i.e. as determined in decision block 604), then the next operation comprises the microprocessor executing a function coded in firmware or other programming to determine if the user is entering data (decision block 606). If yes, then in block 608 the microprocessor updates the focus point (i.e. activity indicator) is updated. If the user is not entering data, then the microprocessor repeats the operations associated with blocks 602, 604 or 606, for example, in a polling loop coded in firmware or other programming.

Referring again to FIG. 6, after the focus point is updated in the step 608, the next operation in decision block 610 comprises determining if the display screen 502 (FIG. 5) for the mobile electronic device 500 (FIG. 5) is set for a variable brightness or intensity mode of operation. If set for variable intensity mode (for example, by the user through a set-up screen), then the next operation in block 612 comprises control circuitry (i.e. the microprocessor 240 operating under stored program control) dimming the display area(s) (for example, the display areas 530 in FIG. 5) outside the vicinity of the area of interest with the focus point. As described above, in one embodiment, the dimming function comprises mapping the pixels for the display screen to an overlay or mask which is then applied to the display screen to present an altered display image, i.e. a display image having region(s) which are dimmed or not as bright as the focus point region or the region of interest. If the variable intensity mode is not set, then the next operation in step 614 comprises control circuitry maintaining the display areas outside of the focus point at a uniform intensity or brightness level. Processing then proceeds to step 602, for example, by a polling loop executed by the microprocessor. The method 600 is typically executed several times per second by the microprocessor 240 (FIG. 2) for the mobile electronic device 200 (FIG. 2). The method 600 is typically implemented as part of either the operating system software or code 260 (FIG. 2) or in one of the software applications 262 (FIG. 2).

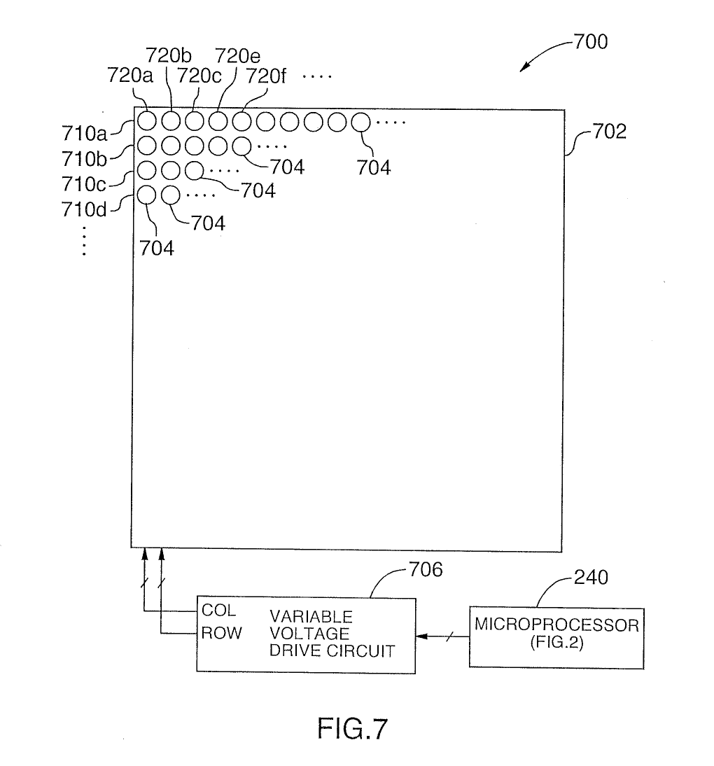

Reference is next made to FIG. 7, which shows a display module according to another embodiment and indicated generally by reference 700. The display module 700 comprises an emissive display screen 702 in which each of the illumination elements, i.e. pixels, comprises an organic light emitting diode or OLED, indicated by reference 704 in FIG. 7. The pixels are arranged in a matrix comprising a plurality of rows 710, indicated individually as 710a, 710b, 710c, 710d, . . . and a plurality of columns 720, indicated individually as 720a, 720b, 720c, 720d, . . . . The OLED's 704 are individually controlled for dimming or brightness control, for example, using a variable voltage drive circuit indicated by reference 706 in FIG. 7. In a manner similar to that described above, the display screen 702 is divided into two or more display areas and the illumination elements (i.e. OLED's 704) are mapped for each of the display areas. Under the control of firmware or other programming the brightness level (i.e. dimming) of the each of the OLED's 704 is varied in relation to the focus point, for example, according to the process described above with respect to FIG. 6. The brightness or dimming level of the OLED's 704 is varied or controlled individually, or in groups, by a function or a code component executed by the microprocessor 240 (FIG. 2) which is interfaced to the variable voltage drive circuit 706, e.g. as an i/o mapped device or an address mapped device. According to another embodiment, the OLED's are replaced by other types of light emitting diodes or illuminating devices which implement individually controllable pixels in the display screen 702.

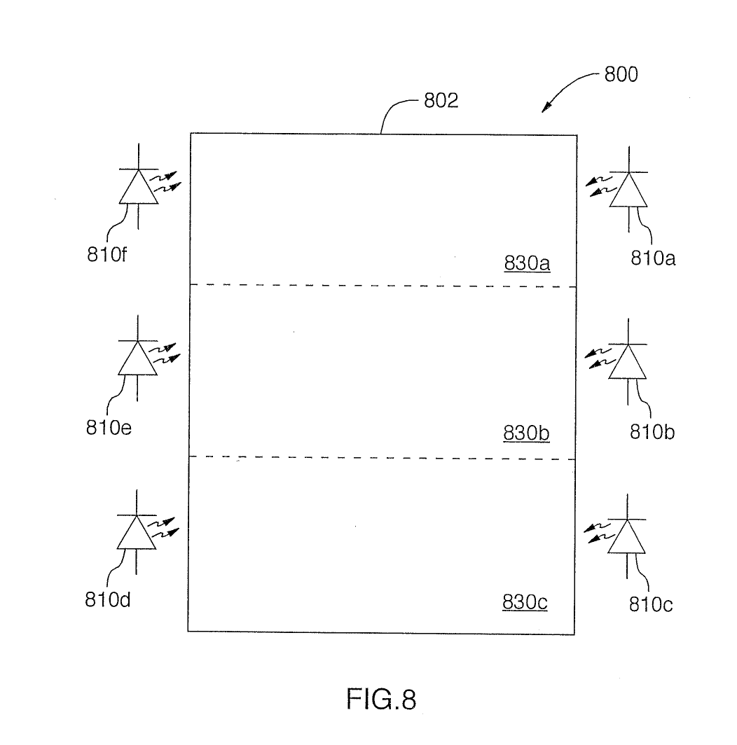

Reference is next made to FIG. 8, which shows a display module according to another embodiment and indicated generally by reference 800. The display module 800 according to this embodiment comprises a display screen 802 and a plurality of lighting components 810. The display screen 802 comprises a transmissive type display (e.g. a liquid crystal display) that includes an array of transmissive light valve elements that implement pixels 310am 310b, 310c . . . such as are shown in the LCD panel 304 of FIG. 3. The lighting components 810 are backlight components that illuminate the display screen 802 from behind, and are indicated individually by references 810a, 810b, 810c, 810d, 810e and 810f. As shown in FIG. 8, the lighting components 810 (i.e. illumination elements) are arranged down two sides of the display screen 802 and function to light or illuminate the display screen 802 or portions of the screen 802 from behind. As shown in FIG. 8, the three lighting components 810a to 810c are arranged down the right hand side of the display screen 802; the three lighting components 810d to 810f are arranged down the left hand side of the display screen 802. In accordance with this embodiment, the display screen 802 is divided into three display areas 830, indicated individually by references 830a, 830b and 830c, respectively. A focus point (i.e. an area of interest) is determined for the display areas 830 in a manner similar to that described above with reference to FIG. 5. Based on the display area 830 with the focus point, the lighting components 810 for the other two display areas 830 are dimmed to reduce power consumption. For example, if the display area 830c has the focus point, then the lighting components 810a and 810f are dimmed for the display area 830a. The other two lighting components 810b and/or 810e may also be dimmed to save power. In another embodiment, if the focus point (i.e. area of interest) is situated, for example, on the left hand side of the display area 830c, then the lighting component 810c on the right hand side may also be dimmed. The lighting components 810 are dimmed by varying the voltage level applied to each of the illumination elements. In one embodiment, each of the lighting components 810 is coupled to an analog voltage terminal or port and the analog voltage level is adjusted or varied by a microprocessor (for example, the microprocessor 240 in FIG. 2) operating under the control of a firmware function or other programming code component. Thus, the display screen 802 of FIG. 8 is similar to the display screen 302 of FIG. 3, except that in the display screen 802, the backlight components 810 are controlled to implement dimming outside of the area of focus, rather that controlling the valve elements that implement the pixels in the LCD panel.

In one embodiment, the focus point or area of interest is determined based on the position of cursor as described above. The focus point may be determined using different types of mechanisms according to other embodiments. In one embodiment, the focus point or area of interest is determined according to the application layer, for example, an email window which has been opened or selected from a number of application windows or screens. In another embodiment, a focus point or an area of interest is created with a tracking mechanism which tracks the focus point or position of the user's eye. The tracking mechanism may comprise apparatus which is worn by the user or a remote interface which tracks the movement and focus position of the user's eye. The determined focus position of the user's eye is transmitted or otherwise conveyed to the controller (for example, the microprocessor 240 in FIG. 2) and a firmware function or other programming routine calculates or determines a corresponding focus point or area of interest on the display screen which is then used for controlling the dimming of the display screen for example as described above with reference to FIG. 5. In another embodiment, the tracking mechanism comprises a camera taking images of the user's eye and sending the image or images to the operating system software which includes a function or module for real time processing. The image processing software calculates a current focus point from the image(s) and this focus point is used for controlling the dimming of the display screen, for example, as described above. The image processing software may refine the focus point as a pixel or define it as a circular area with the radius representing an amount of error.

In another embodiment, the focus point is processed as a “mouse trail” and a tracking mechanism (for example, as described above) tracks the movement of the user's eye. As the user scrolls across the display screen with his eyes, the user would notice in his peripheral vision that the place on the screen he was focussed on would still be lit, but undergoing a dimming function, for example at a defined rate. According to embodiment, the operating system software utilizes a mask which tracks focus points over a particular period of time (e.g. history) and changes the dimming of display screen accordingly.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. A display module comprising:
a display screen;
a controller, said controller having an input for receiving information, and an output coupled to said display screen for outputting display information to said display screen;
said controller including a component for determining an area of interest on said display screen; and
said controller having a component for dimming at least a portion of said display screen outside of said area of interest.

2. The display module as claimed in claim 1, wherein said component for determining an area of interest is responsive to a cursor input on said display screen.

3. The display module as claimed in claim 2, wherein said display screen comprises a normally black transmissive liquid crystal display, said liquid crystal display comprising a plurality of light valve elements, and said component for dimming comprises a mask for dimming a plurality of said light valve elements outside of said area of interest.

4. The display module as claimed in claim 3, wherein the display screen is touch sensitive and said component for determining an area of interest is responsive to a user contacting said touch sensitive display screen.

5. The display module as claimed in claim 1, wherein said display screen comprises an emissive display, said emissive display having a matrix of illumination elements, and at least a plurality of said illumination elements being responsive to said dimming component.

6. The display module as claimed in claim 5, wherein said illumination elements comprise organic light emitting diodes.

7. The display module as claimed in claim 6, wherein said dimming component comprises a device for generating a variable voltage signal, and said organic light emitting diodes being responsive to said variable voltage signal for decreasing or increasing their respective brightness levels.

8. The display module as claimed in claim 1, wherein said display screen comprises a transmissive liquid crystal display that is backlit by a plurality of lighting components, and said component for dimming controls the lighting components to effect the dimming of said display screen outside of said area of interest.

9. The display module as claimed in claim 1 wherein the component for dimming increases the dimming of the area outside of the area of focus as a distance from the area of focus increases.

10. A method of controlling a display for an electronic device, said method comprising the steps of:
displaying an image on the display;
defining an area of interest on the display;
dimming at least a portion of the displayed image outside said area of interest.

11. The method as claimed in claim 10, wherein said step of defining an area of interest comprises monitoring the electronic device for a user input.

12. The method as claimed in claim 11, wherein said user input comprises positioning a cursor on the display, said cursor position defining said area of interest.

13. The method as claimed in claim 11, wherein said display is touch sensitive, and said step of defining an area of interest comprises monitoring said touch sensitive display for a contact position and determining said area of interest based on said contact position.

14. The method as claimed in claim 10, wherein said display comprises a normally black transmissive liquid crystal display, and said step of dimming comprises altering a portion of the image being displayed outside of said area of interest.

15. The method as claimed in claim 10, wherein said display comprises an emissive display having a matrix of illumination elements, said illumination elements being individually controllable for displaying said image.

16. The method as claimed in claim 15, wherein said step of dimming comprises altering a portion of the image being displayed outside of said area of interest.

17. The method as claimed in claim 10 wherein said display comprises a backlit transmissive liquid crystal display, and said step of dimming comprises altering a backlighting of the display outside of said area of interest.

18. A mobile electronic device comprising:
an input device;
a liquid crystal display including,
a display screen;
a controller, said controller having an input for receiving information, and an output coupled to said display screen for outputting display information to said display screen;
said controller including a component for determining an area of interest on said display screen, and said controller having a component for dimming at least a portion of said display screen outside of said area of interest.

19. The mobile electronic device as claimed in claim 18, wherein said component for determining an area of interest is responsive to a cursor input on said display screen.

20. The mobile electronic device as claimed in claim 19, wherein said display screen comprises a normally black transmissive liquid crystal display, and said component for dimming alters a portion of said display screen outside of said area of interest.

21. The mobile electronic device as claimed in claim 19, wherein said display screen comprises an emissive display, and said component for dimming alters a portion of said display screen outside of said area of interest.

22. The mobile electronic device as claimed in claim 21, wherein said illumination elements comprise organic light emitting diodes.

23. The mobile electronic device as claimed in claim 21, wherein said dimming component comprises a circuit for generating a variable voltage signal and said organic light emitting diodes being responsive to said variable voltage signal for decreasing or increasing their respective brightness levels.
